(19) United States
(12) Patent Application Publication
(10) Pub. No.: US 2023/0323032 A1
(43) Pub. Date: Oct. 12, 2023

(54) HIGH-TEMPERATURE ENERGY STORAGE HYBRID POLYETHERIMIDE DIELECTRIC THIN FILM, PREPARATION METHOD THEREFOR, AND USE THEREOF

(71) Applicant: TSINGHUA UNIVERSITY, Beijing (CN)

(72) Inventors: Qi LI, Beijing (CN); Mingcong YANG, Beijing (CN); Jinliang HE, Beijing (CN); Sang CHENG, Beijing (CN)

(21) Appl. No.: 18/333,512

(22) Filed: Jun. 12, 2023

Related U.S. Application Data
(63) Continuation of application No. PCT/CN2020/137757, filed on Dec. 18, 2020.

(51) Int. Cl. C08G 73/10; C08J 5/18; C08K 3/22; H01G 4/33; H01G 4/14

(52) U.S. Cl. CPC C08G 73/1071; C08J 5/18; C08G 73/1032; C08K 3/22; H01G 4/33; H01G 4/14; C08J 2379/08; C08K 2003/2227

(57) ABSTRACT

Provided are a high-temperature energy storage hybrid polyetherimide dielectric film, a preparation method therefor, and use thereof, belonging to the technical field of polymer capacitor films. The method includes: synthesizing a solution of polyether amide acid having a hydroxyl end group or side chain through a reaction of a polyetherimide monomer having a hydroxyl functional group; adding, into the solution of polyether amide acid, water and metal alkoxide as an inorganic component precursor to form uniform sol; and obtaining the high-temperature energy storage hybrid polyetherimide dielectric thin film through coating and thermal imidization. The dielectric thin film is prepared by one-step synthesis and an inorganic phase is introduced during hybridization, dispersion at a molecular level is realized, avoiding an agglomeration of the inorganic phase and improving interface compatibility of the organic phase, as well as enhancing energy storage performance of the dielectric film.

### CROSS-REFERENCE TO RELATED APPLICATIONS

This application is a continuation of International Application No. PCT/CN2020/137757, filed on Dec. 18, 2020, which is hereby incorporated by reference in its entirety.

### FIELD

The present disclosure relates to the technical field of polymer capacitor films, and more particularly, to a high-temperature energy storage hybrid polyetherimide dielectric film, a preparation method therefor, and use thereof.

### BACKGROUND

A dielectric capacitor is a device having a highest power density among energy storage devices, and is one of the main technologies for implementing advanced electronic and power systems. Especially, a capacitor with high operating temperature is critical to the next generation of automobiles and aircraft power systems. In electric vehicles, a power inverter converts a direct current in a battery into an alternating current based on a frequency required to control a motor. Due to a small distance from an engine and the increasingly higher demand for power, it is required a capacitor, as a basic element of the power inverter, to operate above 140° C. The organic thin film capacitors, as capacitors with an organic polymer as a dielectric material, has become a first choice for applications in the above-mentioned fields in light of its characteristics such as a light weight, good processing performance, low production cost, a high dielectric strength, good self-healing, simple integrated assembly process, and no liquid medium.

However, when the existing commercial polymer media such as a biaxially oriented polypropylene film (BOPP) operates at a high electric field above 100° C., dielectric performance thereof significantly deteriorates. In order to improve high-temperature performance of a polymer dielectric, the researchers in the industry around the world have developed and produced polyetherimide materials with a high glass transition temperature. However, such materials can hardly meet application requirements at a high temperature above 150° C. and in a strong electric field above 400 MV/m.

Patent CN103981559B discloses a preparation method for a low-dielectric polyetherimide thin film. A template for electrodeposition is prepared. Then, a soluble polyimide is dissolved into an organic solvent, and an emulsion for electrodeposition is prepared through positively charging a molecular chain by means of molecular modification. A polyimide thin film is electrodeposited on the treated template. Then, the template is etched to introduce air holes into the thin film to reduce a dielectric constant of the polyimide thin film. At last, by coating a polyimide solution and performing thermal treatment, a low dielectric polyimide film can be obtained. However, the steps of the preparation method are complex and difficult to operate, increasing the production cost of the polyetherimide thin film, and it can be hardly applied in the industry.

Patent CN1110045507A discloses a preparation method and use of a cross-linked polyetherimide-based dielectric composite thin film. Nano-ceramic particles having core-shell structures are used as a filler, and a surface of the filler is modified with organic functional groups to introduce cross-linked functional groups. Thus, a network structure is formed through a cross-linking reaction between nanoparticles and polyetherimide matrix, thereby solving problems of dispersity and compatibility of the filler. Meanwhile, the cross-linkable polyetherimide having good heat resistance and mechanical performance is used as a polymer matrix material to prepare the cross-linked polyetherimide-based dielectric composite thin film material having good dielectric property, which has a relatively high dielectric constant and relatively low dielectric loss at room temperature and high temperature. Despite its good dielectric property, the dielectric composite thin film does not have good energy storage performance, which limits the uses thereof.

### SUMMARY

An object of the present disclosure is to provide a high-temperature energy storage hybrid polyetherimide dielectric thin film, a preparation method therefor, and use thereof, thereby enhancing dispersibility of inorganic components and compatibility of the inorganic components with polyetherimide and improving breakdown strength, energy storage density, and comprehensive dielectric performance of a polymer medium at a high temperature of 150° C. or 200° C. and in a strong electric field above 200 MV/m.

The technical solutions of the present disclosure are implemented as follows.

The present disclosure provides a preparation method for a high-temperature energy storage hybrid polyetherimide dielectric thin film. The method includes: synthesizing a solution of polyether amide acid having a hydroxyl end group or side chain through a reaction of a polyetherimide monomer having a hydroxyl functional group; adding, into the solution of polyether amide acid, water and metal alkoxide as an inorganic component precursor to form uniform sol; and obtaining the high-temperature energy storage hybrid polyetherimide dielectric thin film through coating and thermal imidization.

As a further improvement of the present disclosure, the preparation method includes: step S1 of performing polymerization of dianhydride, diamine and another diamine having a hydroxyl functional group in anhydrous aprotic solvent to obtain a hydroxyl-functionalized polyether amide acid solution; step S2 of adding water into anhydrous aprotic solvent, mixing evenly, and adding the mixture into the solution of polyether amide acid obtained in step S1; step S3 of adding metal alkoxide into anhydrous aprotic solvent, mixing evenly, adding the mixture into the solution of polyether amide acid obtained in step S2, and stirring for 1 hour to 3 hours at room temperature to mix thoroughly, to obtain hybrid polyether amide acid slurry; and step S4 of preparing a thin film with the slurry obtained in step S3, and performing thermal imidization on the obtained thin film through heating, to obtain the high-temperature energy storage hybrid polyetherimide dielectric thin film.

As a further improvement of the present disclosure, in the step S1, a molar ratio of the dianhydride, the diamine, and the diamine having the hydroxyl functional group is (1.01 to 1.02):(0.9 to 0.995):(0.01 to 0.2); a ratio of acid anhydride to amino functional group is 1.02:1; the dianhydride is added in batches; the polymerization is performed at a temperature in a range from 20° C. to 30° C. for 1 hour to 6 hours; and a solid content of the obtained hydroxyl-functionalized polyether amide acid solution ranges from 3% to 15%.

As a further improvement of the present disclosure, the dianhydride is selected from the group consisting of 2,2′-bis[3,4-dicarboxylphenoxyphenyl]dianhydride propane (bisphenol A diether dianhydride (BPADA)), 3,3′,4,4′-biphenyltetracarboxylic dianhydride (BPDA), 3,3′,4,4′-benzophenonetetracarboxylic dianhydride (BTDA), 4,4′-oxydiphthalic anhydride (ODPA), 2,3,3′,4′-diphenylethertetracarboxylic dianhydride (a-ODPA), 4,4′-(hexafluoroisopropylidene)diphthalic anhydride (6FDA), and combinations thereof; the diamine is selected from the group consisting of m-phenylenediamine (MPD), p-phenylenediamine (PPD), 4,4′-diaminodiphenyl ether (ODA), and combinations thereof; and the diamine having the hydroxyl functional group is selected from the group consisting of p-aminobenzyl alcohol, o-aminobenzyl alcohol, m-aminobenzyl alcohol, and 4,4′-diamino-4′-hydroxytriphenylmethane.

As a further improvement of the present disclosure, a quantity of the water added in the step S2 depends on a quantity of the metal alkoxide added in the step S3; and a molar ratio of the water to the metal alkoxide is 1:(3 to 6).

As a further improvement of the present disclosure, in step S3, the metal alkoxide is selected from the group consisting of titanium methoxide, nickel methoxide, copper methoxide, tin methoxide, tantalum methoxide, titanium ethoxide, iron ethoxide, copper ethoxide, aluminum ethoxide, gallium ethoxide, zirconium ethoxide, niobium ethoxide, molybdenum ethoxide, tin ethoxide, hafnium ethoxide, tantalum ethoxide, tungsten ethoxide, thallium ethoxide, titanium propoxide, titanium isopropoxide, vanadium isopropoxide, chromium isopropoxide, iron isopropoxide, cobalt isopropoxide, copper isopropoxide, aluminum propoxide, aluminum isopropoxide, gallium isopropoxide, yttrium isopropoxide, zirconium propoxide, zirconium isopropoxide, niobium propoxide, niobium isopropoxide, molybdenum isopropoxide, indium isopropoxide, tin isopropoxide, tantalum isopropoxide, tungsten isopropoxide, bismuth isopropoxide, lanthanum isopropoxide, cerium isopropoxide, praseodymium isopropoxide, neodymium isopropoxide, samarium isopropoxide, gadolinium isopropoxide, dysprosium isopropoxide, holmium isopropoxide, erbium isopropoxide, ytterbium isopropoxide, titanium butoxide, titanium isobutoxide, titanium tert-butoxide, aluminum butoxide, aluminum tert-butoxide, aluminum sec-butoxide, zirconium butoxide, zirconium tert-butoxide, niobium butoxide, hafnium tert-butoxide, tantalum butoxide, niobium pentoxide, and bismuth tert-pentoxide; and a mass ratio of the metal alkoxide to the polyether amide acid is in a range from 2.5% to 25%.

As a further improvement of the present disclosure, the anhydrous aprotic solvent is selected from the group consisting of N,N-dimethylacetamide (DMAC), N,N-dimethylformamide (DMF), N-methylpyrrolidone (NMP), and dimethyl sulfoxide (DMSO); and a water content of the aprotic solvent is smaller than 50 ppm.

As a further improvement of the present disclosure, in step S4, the thermal imidization is performed by heating to a temperature ranging from 70° C. to 90° C. and holding the temperature 6 hours to 10 hours, heating to a temperature ranging from 140° C. to 160° C. and holding the temperature 0.5 hour to 1.5 hours, heating to a temperature ranging from 190° C. to 210° C. and holding the temperature 0.5 hour to 1.5 hours, and heating to a temperature ranging from 240° C. to 260° C. and holding the temperature 0.5 hour to 1.5 hours, sequentially.

The present disclosure further provides a high-temperature energy storage hybrid polyetherimide dielectric thin film prepared by the preparation method described above.

The present disclosure further provides use of the high-temperature energy storage hybrid polyetherimide dielectric thin film described above.

The present disclosure has the following beneficial effects.

1. Hybrid polyetherimide is prepared through one-step synthesis. The preparation method is simple. The reactions are all carried out in a liquid phase, which can be sufficiently compatible with a current industrial production process of polyetherimide.

2. In the obtained hybrid composite material according to the present disclosure, dispersion of the inorganic phase at a molecular level is realized through covalent bonding of a hybrid region, significantly reducing interface defects of the organic phase and the inorganic phase, and improving interface compatibility. FIG. 3 is an existence form of the organic-inorganic phases of the hybrid composite material. As illustrated in FIG. 3, the hybrid region is a transition between the organic phase and the inorganic phase, thereby solving a problem of an agglomeration of the inorganic phase in a conventional composite system.

3. In the present disclosure, as illustrated in FIG. 4, by doping the inorganic phase, discretely distributed deep traps are introduced into the polymer material. Under a high-temperature strong electric field, free electrons injected by an electrode or thermally excited are captured and bound by the deep traps of the inorganic phase, such that the breakdown field strength and energy storage efficiency of the material are increased, thereby improving the energy storage density of the dielectric material.

4. The energy storage density of obtained hybrid dielectric material according to the present disclosure can reach 4.0 J/cm³ to 5.2 J/cm³ at 150° C. and the efficiency of 90%, and can further reach 2.0 J/cm³ to 3.64 J/cm³ at 200° C. and the efficiency of 90%, which greatly exceeds the existing dielectric media. In addition, other performances such as breakdown strength, current leakage, and glass transition temperature are also improved, such that the comprehensive dielectric performance is good.

### BRIEF DESCRIPTION OF THE DRAWINGS

In order to clearly explain technical solutions of embodiments of the present disclosure or technical solutions in the related art, drawings used in description of the embodiments or the related art will be briefly described below. The drawings described below merely illustrate some embodiments of the present disclosure. Based on these drawings, other drawings can be obtained by those skilled in the art without creative effort.

FIG. 1 is a chemical structural formula of a hydroxy-functionalized polyether amide acid.

FIG. 2 is a chemical structural formula of a hybrid polyetherimide.

FIG. 3 is a schematic diagram of an existence form of organic-inorganic phases of a hybrid composite material.

FIG. 4 is a schematic diagram of discretely distributed deep traps formed inside a polymer material.

FIG. 5 is a graph of energy storage performance at 150° C. of an aluminum oxide/polyetherimide dielectric thin film prepared in Example 1.

FIG. 6 is a graph of energy storage performance at 200° C. of an aluminum oxide/polyetherimide dielectric thin film prepared in Example 1.

FIG. 7 is a graph of energy storage performance at 150° C. of a tantalum oxide/polyetherimide dielectric thin film prepared in Example 2.

FIG. 8 is a graph of energy storage performance at 200° C. of a tantalum oxide/polyetherimide dielectric thin film prepared in Example 2.

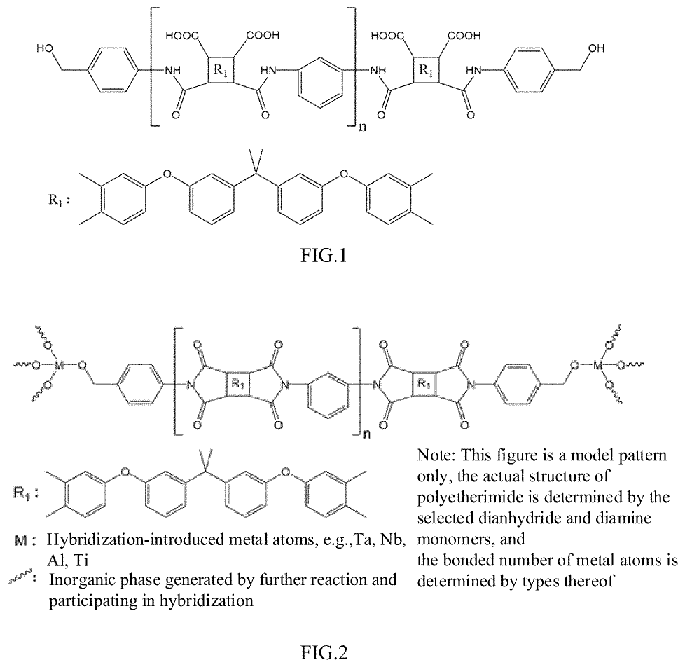

### DETAILED DESCRIPTION

Technical solutions according to embodiments of the present disclosure will be described clearly and thoroughly below. Obviously, the embodiments described below are only a part of the embodiments of the present disclosure, rather than all embodiments of the present disclosure. Based on the embodiments of the present disclosure, all other embodiments obtained by those skilled in the art without paying creative efforts shall fall within the protection scope of the present disclosure.

In the present disclosure, the high-temperature energy storage hybrid polyetherimide dielectric thin film is prepared by using the following sol-gel method. A thin film preparation process may include the following steps.

Step S1: preparation of hydroxyl-functionalized polyether amide acid solution. Diamine and diamine having a hydroxyl functional group are weighed and dissolved in anhydrous aprotic solvent. After the diamine is completely dissolved through stirring, dianhydride is added into the mixture in three batches under stirring. One batch of dianhydride is added every five minutes, and it is ensured that the dianhydride added in the previous batch has been completely dissolved. When the last batch of dianhydride is added, viscosity of the solution is significantly increased, and the reaction is ended. The solution is stirred at 25° C. for 1 hour to obtain a solution of polyether amide acid having a solid content of 3% to 15%.

Step S2: preparation of anhydrous proton solvent containing trace amount of water. Trace amount of water is taken using a pipette and uniformly dispersed into 2 mL of the anhydrous aprotic solvent to obtain an anhydrous proton solvent containing trace amount of water.

Step S3: preparation of hybrid polyether amide acid slurry. The anhydrous aprotic solvent containing the trace amount of water obtained in step S2 is added into the solution of polyether amide acid obtained in step S1, and is dispersed uniformly by stirring for 10 minutes. A metal alkoxide is taken using a pipette (when the alkoxide is in a solid state, the amount is measured) and is uniformly dispersed into anhydrous aprotic solvent while stirring. Then, the metal alkoxide solution is added to the above-mentioned polyether amide acid solution, and stirred at room temperature for 1 hour to obtain the hybrid polyether amide slurry.

Step S4: preparation of hybrid polyetherimide thin film. The hybrid polyether amide acid slurry is dropwise added onto a clean glass plate to coated the glass plate with a certain thickness. The glass plate is then placed into an oven to perform thermal imidization on hybrid polyamic acid. A heating procedure is as follow: heating to a temperature of 80° C. and holding the temperature 8 hours, heating to a temperature of 150° C. and holding the temperature 1 hour, heating to a temperature of 200° C. and holding the temperature 1 hour, and heating to a temperature of 250° C. and holding the temperature 1 hour. After the imidization reaction is completed, the thin film is removed from the glass plate to obtain the hybrid polyetherimide dielectric film with a certain thickness.

In the film preparation process described above, the anhydrous aprotic solvent includes one of N,N-dimethylacetamide (DMAC), N,N-dimethylformamide (DMF), N-methylpyrrolidone (NMP), and dimethyl sulfoxide (DMSO), all of which have a water content below 50 mmp.

The dianhydride in the above-mentioned film preparation process includes 2,2′-bis[3,4-dicarboxylphenoxyphenyl]dianhydride propane (bisphenol A diether dianhydride (BPADA)), 3,3′,4,4′-biphenyltetracarboxylic dianhydride (BPDA), 3,3′,4,4′-benzophenonetetracarboxylic dianhydride (BTDA), 4,4′-oxydiphthalic anhydride (ODPA), 2,3,3′,4′-diphenylethertetracarboxylic dianhydride (a-ODPA), 4,4′-(hexafluoroisopropylidene)diphthalic anhydride (6 FDA), or combinations thereof.

The diamine in the above-mentioned film preparation process includes m-phenylenediamine (MPD), p-phenylenediamine (PPD), 4,4′-diaminodiphenyl ether (ODA), or combinations thereof.

The diamine having the hydroxyl functional group in the above-mentioned film preparation process is selected from the group consisting of p-aminobenzyl alcohol, o-aminobenzyl alcohol, m-aminobenzyl alcohol, and 4,4′-diamino-4′-hydroxytriphenylmethane.

The metal alkoxide in the above-mentioned film preparation process is selected from the metal alkoxide is selected from the group consisting of titanium methoxide, nickel methoxide, copper methoxide, tin methoxide, tantalum methoxide, titanium ethoxide, iron ethoxide, copper ethoxide, aluminum ethoxide, gallium ethoxide, zirconium ethoxide, niobium ethoxide, molybdenum ethoxide, tin ethoxide, hafnium ethoxide, tantalum ethoxide, tungsten ethoxide, thallium ethoxide, titanium propoxide, titanium isopropoxide, vanadium isopropoxide, chromium isopropoxide, iron isopropoxide, cobalt isopropoxide, copper isopropoxide, aluminum propoxide, aluminum isopropoxide, gallium isopropoxide, yttrium isopropoxide, zirconium propoxide, zirconium isopropoxide, niobium propoxide, niobium isopropoxide, molybdenum isopropoxide, indium isopropoxide, tin isopropoxide, tantalum isopropoxide, tungsten isopropoxide, bismuth isopropoxide, lanthanum isopropoxide, cerium isopropoxide, praseodymium isopropoxide, neodymium isopropoxide, samarium isopropoxide, gadolinium isopropoxide, dysprosium isopropoxide, holmium isopropoxide, erbium isopropoxide, ytterbium isopropoxide, titanium butoxide, titanium isobutoxide, titanium tert-butoxide, aluminum butoxide, aluminum tert-butoxide, aluminum sec-butoxide, zirconium butoxide, zirconium tert-butoxide, niobium butoxide, hafnium tert-butoxide, tantalum butoxide, niobium pentoxide, and bismuth tert-pentoxide.

### Example 1

Raw material compositions and ratio thereof:

| | |
|---|---|
| bisphenol A diether dianhydride | 426.9 mg |
| m-phenylenediamine | 87.4 mg |
| p-aminobenzyl alcohol | 1.0 mg |
| water | 10.5 μL |
| aluminum sec-butoxide | 49.8 μL |
| anhydrous N-methylpyrrolidone | 14 mL |

### Preparation Method

Preparation of hydroxyl-functionalized polyether amide acid solution: 87.4 mg of m-phenylenediamine and 1.0 mg of p-aminobenzyl alcohol were weighed and dissolved in 7 mL of anhydrous N-methylpyrrolidone. After the diamine was completely dissolved through stirring, 426.9 mg of bisphenol A diether dianhydride (BPADA) was added into the mixture in three batches under stirring. One batch of dianhydride was added every 5 minutes, and it was ensured that the dianhydride added in the previous batch had been completely dissolved. When the last batch of dianhydride was added, viscosity of the solution was significantly increased, and the reaction was ended. The solution was stirred at 25° C. for 1 hour to obtain a solution of polyether amide acid having a solid content of 6.7%.

Preparation of hybrid aluminum oxide/polyetherimide acid slurry: 10.5 μL of water was taken using a pipette and uniformly dispersed into 2 mL of anhydrous N-methylpyrrolidone. Then, the mixture was added into the solution of polyether amide acid obtained in the previous step. The mixture was stirred for 10 minutes to be dispersed uniformly. 49.8 μL of sec-butoxide was taken using a pipette and uniformly dispersed into 5 mL of anhydrous N-methylpyrrolidone while stirring. Then, an aluminum sec-butoxide solution was added to the above-mentioned polyether amide acid solution, and stirred at room temperature for 1 hour to obtain a hybrid aluminum oxide/polyether amide acid slurry.

Preparation of hybrid aluminum oxide/polyetherimide film: 1.8 mL of hybrid aluminum oxide/polyether amide acid slurry was dropwise added onto a clean glass plate (50 mm×50 mm) to uniformly apply the hybrid aluminum oxide/polyether amide acid slurry on the entire glass plate. The glass plate was then placed into an oven to perform thermal imidization on the hybrid aluminum oxide/polyether amide acid. The heating procedure was as follow: heating to a temperature of 80° C. and holding the temperature 8 hours, heating to a temperature of 150° C. and holding the temperature 1 hour, heating to a temperature of 200° C. and holding the temperature 1 hour, and heating to a temperature of 250° C. and holding the temperature 1 hour. After the imidization reaction was completed, the thin film was removed from the glass plate to obtain a high-temperature energy storage hybrid aluminum oxide/polyetherimide dielectric thin film with a thickness of 11 μm.

The anhydrous N-methylpyrrolidone was N-methylpyrrolidone having a water content smaller than 50 ppm.

FIG. 5 illustrates energy storage performance at 150° C. of the obtained aluminum oxide/polyetherimide dielectric thin film. The energy storage efficiency is up to 90%, and an energy storage density reaches 5.20 J/cm³, under a field strength of 600 MV/m. Comparing with the pure polyetherimide (commercially available, manufacturer SABIC Research & Development Co., Ltd., name: Ultem 1000), also at the energy storage efficiency of 90%, the field strength thereof is 400 MV/m, and the energy storage density thereof is merely 2.34 J/cm³. Regarding the hybrid aluminum oxide/polyetherimide dielectric thin film prepared according to the present disclosure, the energy storage density thereof at 150° C. and the energy storage efficiency of 90% is increased by 122% compared to the commercially available polyetherimide.

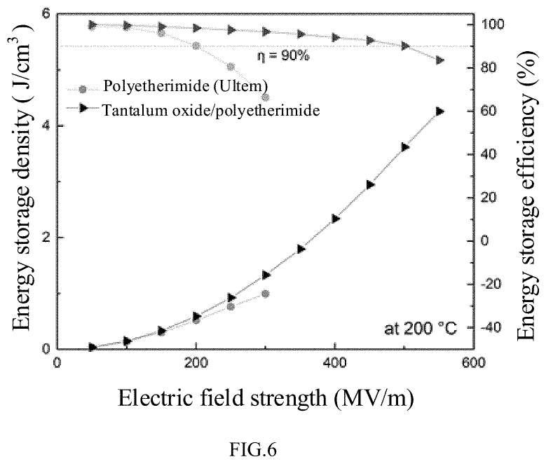

FIG. 6 illustrates energy storage performance at 200° C. of the obtained aluminum oxide/polyetherimide dielectric thin film. The energy storage efficiency is up to 90%, and an energy storage density reaches 3.62 J/cm³, under a field strength of 500 MV/m. Comparing with the pure polyetherimide (commercially available, manufacturer SABIC Research & Development Co., Ltd., name: Ultem 1000), also at the energy storage efficiency of 90%, the field strength thereof is 200 MV/m, and the energy storage density thereof is merely 0.52 J/cm³. Regarding the hybrid aluminum oxide/polyetherimide dielectric thin film prepared according to the present disclosure, the energy storage density thereof at 200° C. and the energy storage efficiency of 90% is increased by 596% compared to the commercially available polyetherimide.

### Example 2

Raw material composition and ratio thereof:

| | |
|---|---|
| bisphenol A diether dianhydride | 426.9 mg |
| m-phenylenediamine | 87.4 mg |
| p-aminobenzyl alcohol | 1.0 mg |
| water | 15.8 μL |
| tantalum ethoxide | 45.7 μL |
| anhydrous N-methylpyrrolidone | 14 mL |

### Preparation Method

Preparation of hydroxyl-functionalized polyether amide acid solution: 87.4 mg of m-phenylenediamine and 1.0 mg of p-aminobenzyl alcohol were weighed and dissolved in 7 mL of anhydrous N-methylpyrrolidone. After the diamine was completely dissolved through stirring, 426.9 mg of bisphenol A diether dianhydride (BPADA) was added into the mixture in three batches under stirring. One batch of dianhydride was added every 5 minutes, and it was ensured that the dianhydride added in the previous batch had been completely dissolved. When the last batch of dianhydride was added, viscosity of the solution was significantly increased, and the reaction was ended. The solution was stirred at 25° C. for 1 hour to obtain a solution of polyether amide acid having a solid content of 6.7%.

Preparation of hybrid tantalum oxide/polyetherimide acid slurry: 15.8 μL of water was taken using a pipette and uniformly dispersed into 2 mL of anhydrous N-methylpyrrolidone. Then, the mixture was added into the solution of polyether amide acid obtained in the previous step. The mixture was stirred for 10 minutes to be dispersed uniformly. 45.7 μL of tantalum ethoxide was taken using a pipette and uniformly dispersed into 5 mL of anhydrous N-methylpyrrolidone while stirring. Then, a tantalum ethoxide solution was added to the above-mentioned polyether amide acid solution, and stirred at room temperature for 1 hour to obtain a hybrid tantalum oxide/polyether amide acid slurry.

Preparation of hybrid tantalum oxide/polyetherimide thin film: 1.8 mL of hybrid tantalum oxide/polyether amide acid slurry was dropwise added onto a clean glass plate (50 mm×50 mm) to uniformly apply the hybrid tantalum oxide/polyether amide acid slurry on the entire glass plate. The glass plate was then placed into an oven to perform thermal imidization on the hybrid tantalum oxide/polyether amide acid. The heating procedure was as follow: heating to a temperature of 80° C. and holding the temperature 8 hours, heating to a temperature of 150° C. and holding the temperature 1 hour, heating to a temperature of 200° C. and holding the temperature 1 hour, and heating to a temperature of 250° C. and holding the temperature 1 hour. After the imidization reaction was completed, the thin film was removed from the glass plate to prepare a high-temperature energy storage hybrid tantalum oxide/polyetherimide dielectric thin film with a thickness of 11 μm.

The anhydrous N-methylpyrrolidone was N-methylpyrrolidone having a water content smaller than 50 ppm.

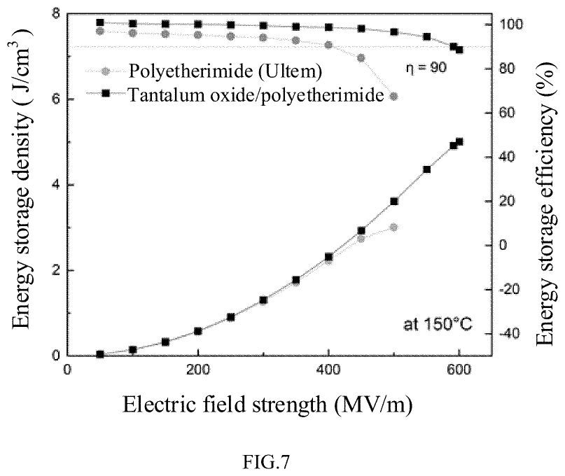

FIG. 7 illustrates energy storage performance at 150° C. of the obtained tantalum oxide/polyetherimide dielectric thin film. The energy storage efficiency is up to 90%, and an energy storage density reaches 4.91 J/cm³, under a field strength of 591 MV/m. Comparing with the pure polyetherimide (commercially available, manufacturer SABIC Research & Development Co., Ltd., name: Ultem 1000), also at the energy storage efficiency of 90%, the field strength thereof is 400 MV/m, and the energy storage density thereof is merely 2.34 J/cm³. Regarding the hybrid aluminum oxide/polyetherimide dielectric thin film prepared according to the present disclosure, the energy storage density thereof at 150° C. and the energy storage efficiency of 90% is increased by 110% compared to the commercially available polyetherimide.

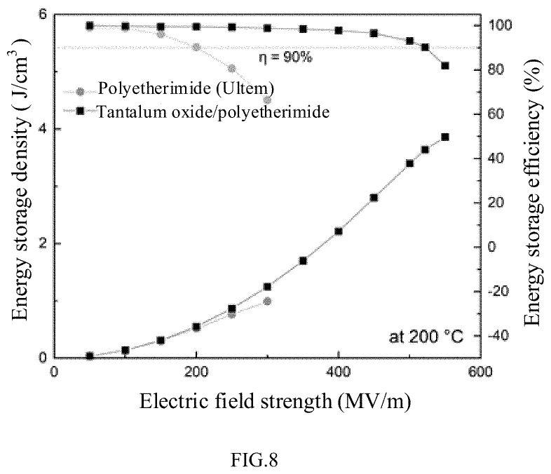

FIG. 8 illustrates energy storage performance at 200° C. of the obtained tantalum oxide/polyetherimide dielectric thin film. The energy storage efficiency is up to 90%, and an energy storage density reaches 3.62 J/cm³, under a field strength of 522 MV/m. Comparing with the pure polyetherimide (commercially available, manufacturer SABIC Research & Development Co., Ltd., name: Ultem 1000), also at the energy storage efficiency of 90%, the field strength thereof is 200 MV/m, and the energy storage density thereof is merely 0.52 J/cm³. Regarding the hybrid aluminum oxide/polyetherimide dielectric thin film prepared according to the present disclosure, the energy storage density thereof at 200° C. and the energy storage efficiency of 90% is increased by 600% compared to the commercially available polyetherimide.

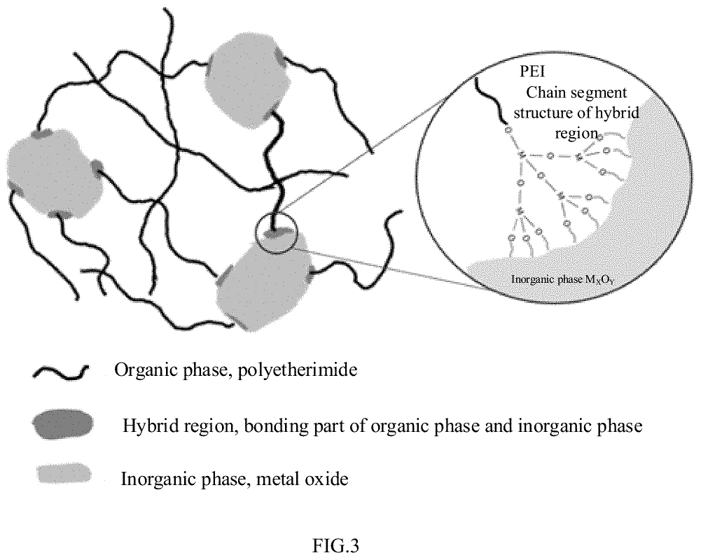

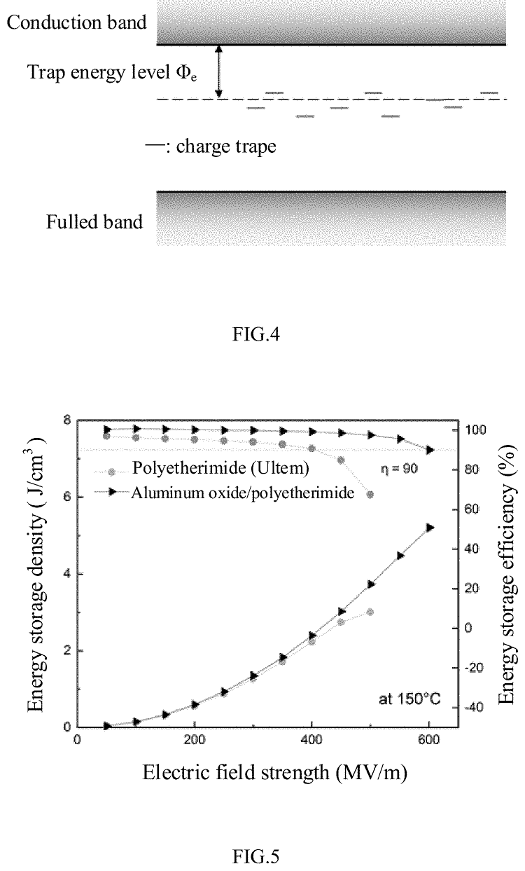

Compared with the related art, for the hybrid polyetherimide prepared by the one-step synthesis, the preparation method is simple, and the reactions are all carried out in the liquid phase, which can be fully compatible with the current industrial production process of polyetherimide. In the obtained hybrid composite material according to the present disclosure, dispersion of the inorganic phase at a molecular level is realized through covalent bonding of a hybrid region, significantly reducing interface defects of the organic phase and the inorganic phase, and improving interface compatibility. FIG. 3 is an existence form of the organic-inorganic phases of the hybrid composite material. As illustrated in FIG. 3, the hybrid region is a transition between the organic phase and the inorganic phase, thereby solving a problem of an agglomeration of the inorganic phase in a conventional composite system. In the present disclosure, as illustrated in FIG. 4, by doping the inorganic phase, discretely distributed deep traps are introduced into the polymer material. Under a high-temperature strong electric field, free electrons injected by an electrode or thermally excited are captured and bound by the deep traps of the inorganic phase, such that the breakdown field strength and energy storage efficiency of the material are increased, thereby improving the energy storage density of the dielectric material. The energy storage density of obtained hybrid dielectric material according to the present disclosure can reach 4.0 J/cm³ to 5.2 J/cm³ at 150° C. and the efficiency of 90%, and can further reach 2.0 J/cm³ to 3.64 J/cm³ at 200° C. and the efficiency of 90%, which greatly exceeds the existing dielectric media. In addition, other performances such as breakdown strength, current leakage, and glass transition temperature are also improved, such that the comprehensive dielectric performance is good.

While the optional embodiments of the present disclosure have been described above, the present disclosure is not limited to these embodiments. Any modification, equivalent substitution, improvement, etc., made within the concept and principles of the present disclosure shall fall within the protection scope of the present disclosure.

What is claimed is:

1. A preparation method for a high-temperature energy storage hybrid polyetherimide dielectric thin film, comprising:
synthesizing a solution of polyether amide acid having a hydroxyl end group or side chain through a reaction of a polyetherimide monomer having a hydroxyl functional group;
adding, into the solution of polyether amide acid, water and metal alkoxide as an inorganic component precursor to form uniform sol; and
obtaining the high-temperature energy storage hybrid polyetherimide dielectric thin film through coating and thermal imidization.

2. The preparation method for the high-temperature energy storage hybrid polyetherimide dielectric thin film according to claim 1, comprising:
step S1 of performing polymerization of dianhydride, diamine and another diamine having a hydroxyl functional group in anhydrous aprotic solvent to obtain a hydroxyl-functionalized polyether amide acid solution;
step S2 of adding water into anhydrous aprotic solvent, mixing evenly, and adding the mixture into the solution of polyether amide acid obtained in step S1;
step S3 of adding metal alkoxide into anhydrous aprotic solvent, mixing evenly, adding the mixture into the solution of polyether amide acid obtained in step S2, and stirring for 1 hour to 3 hours at room temperature to mix thoroughly, to obtain hybrid polyether amide acid slurry; and
step S4 of preparing a thin film with the slurry obtained in step S3, and performing thermal imidization on the obtained thin film through heating, to obtain the high-temperature energy storage hybrid polyetherimide dielectric thin film.

3. The preparation method for the high-temperature energy storage hybrid polyetherimide dielectric thin film according to claim 2, wherein in the step S1:
a molar ratio of the dianhydride, the diamine, and the diamine having the hydroxyl functional group is (1.01 to 1.02):(0.9 to 0.995):(0.01 to 0.2);
a ratio of acid anhydride to amino functional group is 1.02:1;
the dianhydride is added in batches;
the polymerization is performed at a temperature in a range from 20° C. to 30° C. for 1 hour to 6 hours; and
a solid content of the obtained hydroxyl-functionalized polyether amide acid solution ranges from 3% to 15%.

4. The preparation method for the high-temperature energy storage hybrid polyetherimide dielectric thin film according to claim 2, wherein:
the dianhydride is selected from the group consisting of 2,2′-bis[3,4-dicarboxylphenoxyphenyl]dianhydride propane, 3,3′,4,4′-biphenyltetracarboxylic dianhydride, 3,3′,4,4′-benzophenonetetracarboxylic dianhydride, 4,4′-oxydiphthalic anhydride, 2,3,3′,4′-diphenylethertetracarboxylic dianhydride, 4,4′-(hexafluoroisopropylidene)diphthalic anhydride, and combinations thereof;
the diamine is selected from the group consisting of m-phenylenediamine, p-phenylenediamine, 4,4′-diaminodiphenyl ether, and combinations thereof; and
the diamine having the hydroxyl functional group is selected from the group consisting of p-aminobenzyl alcohol, o-aminobenzyl alcohol, m-aminobenzyl alcohol, and 4,4′-diamino-4′-hydroxytriphenylmethane.

5. The preparation method for the high-temperature energy storage hybrid polyetherimide dielectric thin film according to claim 2, wherein:
a quantity of the water added in the step S2 depends on a quantity of the metal alkoxide added in the step S3; and
a molar ratio of the water to the metal alkoxide is 1:(3 to 6).

6. The preparation method for the high-temperature energy storage hybrid polyetherimide dielectric thin film according to claim 2, wherein in step S3:
the metal alkoxide is selected from the group consisting of titanium methoxide, nickel methoxide, copper methoxide, tin methoxide, tantalum methoxide, titanium ethoxide, iron ethoxide, copper ethoxide, aluminum ethoxide, gallium ethoxide, zirconium ethoxide, niobium ethoxide, molybdenum ethoxide, tin ethoxide, hafnium ethoxide, tantalum ethoxide, tungsten ethoxide, thallium ethoxide, titanium propoxide, titanium isopropoxide, vanadium isopropoxide, chromium isopropoxide, iron isopropoxide, cobalt isopropoxide, copper isopropoxide, aluminum propoxide, aluminum isopropoxide, gallium isopropoxide, yttrium isopropoxide, zirconium propoxide, zirconium isopropoxide, niobium propoxide, niobium isopropoxide, molybdenum isopropoxide, indium isopropoxide, tin isopropoxide, tantalum isopropoxide, tungsten isopropoxide, bismuth isopropoxide, lanthanum isopropoxide, cerium isopropoxide, praseodymium isopropoxide, neodymium isopropoxide, samarium isopropoxide, gadolinium isopropoxide, dysprosium isopropoxide, holmium isopropoxide, erbium isopropoxide, ytterbium isopropoxide, titanium butoxide, titanium isobutoxide, titanium tert-butoxide, aluminum butoxide, aluminum tert-butoxide, aluminum sec-butoxide, zirconium butoxide, zirconium tert-butoxide, niobium butoxide, hafnium tert-butoxide, tantalum butoxide, niobium pentoxide, and bismuth tert-pentoxide; and
a mass ratio of the metal alkoxide to the polyether amide acid is in a range from 2.5% to 25%.

7. The preparation method for the high-temperature energy storage hybrid polyetherimide dielectric thin film according to claim 2, wherein:
the anhydrous aprotic solvent is selected from the group consisting of N,N-dimethylacetamide, N,N-dimethylformamide, N-methylpyrrolidone, and dimethyl sulfoxide; and
a water content of the aprotic solvent is smaller than 50 ppm.

8. The preparation method for the high-temperature energy storage hybrid polyetherimide dielectric thin film according to claim 2, wherein in step S4, the thermal imidization is performed by heating to a temperature ranging from 70° C. to 90° C. and holding the temperature 6 hours to 10 hours, heating to a temperature ranging from 140° C. to 160° C. and holding the temperature 0.5 hour to 1.5 hours, heating to a temperature ranging from 190° C. to 210° C. and holding the temperature 0.5 hour to 1.5 hours, and heating to a temperature ranging from 240° C. to 260° C. and holding the temperature 0.5 hour to 1.5 hours, sequentially.

9. A high-temperature energy storage hybrid polyetherimide dielectric thin film prepared by the preparation method according to claim 1.

10. Use of the high-temperature energy storage hybrid polyetherimide dielectric thin film according to claim 9 in a dielectric capacitor.
